(19) United States
(12) Patent Application Publication
(10) Pub. No.: US 2014/0265191 A1
(43) Pub. Date: Sep. 18, 2014

(54) Hand Truck

(71) Applicant: TAIWAN SHIN YEH ENTERPRISE CO., LTD., Chiayi Hsien (TW)

(72) Inventor: Chuen-Jong Tseng, Chiayi Hsien (TW)

(73) Assignee: Taiwan Shin Yeh Enterprise Co., Ltd., Chiayi Hsien (TW)

(21) Appl. No.: 13/845,222

(22) Filed: Mar. 18, 2013

(51) Int. Cl. B62B 1/02

(52) U.S. Cl. CPC B62B 1/02
USPC 280/47.27

(57) ABSTRACT

A hand truck includes a movable main body including a bottom frame and a reclining frame, and a push member fulcrumed to the reclining frame and having a driving portion that is disposed above the bottom frame. The push member is operable between a non-pushing position where the driving portion is retracted backward to permit placement of an object on the bottom frame, and a pushing position where the driving portion extends forward from the reclining frame to push the object forward and outward from the bottom frame. The hand truck further includes a first resilient member connected between the main body and the push member for biasing the push member toward the non-pushing position.

### BACKGROUND OF THE INVENTION

1. Field of the Invention

The invention relates to a human-powered transport, more particularly to a hand truck.

2. Description of the Related Art

Referring to FIG. 1, Taiwanese Utility Model Patent No. M279557 discloses a conventional hand truck 9 that includes a bottom frame 91, a support frame 92 extending upwardly from the bottom frame 91, and a pair of wheels 93 connected to a lower end of the support frame 92. When the conventional hand truck 9 is in use, an object to be transported is placed on the bottom frame 91 and reclines against the support frame 92.

After reaching a destination, the object needs to be lifted manually to be removed from the bottom frame 91. However, such operation is laborious and time-consuming, which leads to a relatively low transport efficiency.

### SUMMARY OF THE INVENTION

Therefore, the object of the present invention is to provide a hand truck that is labor-saving when in use.

Accordingly, a hand truck of the present invention is adapted for transporting an object, and comprises:

a movable main body including
a bottom frame adapted for supporting the object, and
a reclining frame extending upwardly from a rear edge of the bottom frame;

a push member fulcrumed to the reclining frame and having a driving portion that is disposed above the bottom frame, the push member being operable to move between a non-pushing position where the driving portion is retracted backward to permit placement of the object on the bottom frame, and a pushing position where the driving portion extends forward from the reclining frame to push the object forward and outward from the bottom frame; and

a first resilient member connected between the main body and the push member for biasing the push member toward the non-pushing position.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a conventional hand truck disclosed in Taiwanese Utility Model Patent No. M279557;

FIG. 2 is a perspective view of a preferred embodiment of a hand truck according to the invention;

FIG. 3 is a fragmentary perspective view of the preferred embodiment;

FIG. 4 is a fragmentary sectional view of the preferred embodiment, illustrating a push member at a non-pushing position; and

FIG. 5 is another fragmentary sectional view of the preferred embodiment, illustrating the push member at a pushing position.

### DETAILED DESCRIPTION OF THE PREFERRED EMBODIMENT

As shown in FIGS. 2, 3, 4 and 5, a preferred embodiment of a hand truck according to the present invention is adapted for transporting an object 8, and comprises a movable main body 1, a fulcrum shaft 20 mounted to the main body 1, a push member 2 fulcrumed about the fulcrum shaft 20, a first resilient member 3 connected between the main body 1 and the push member 2, and a second resilient member 4 installed on the push member 2.

The main body 1 includes a bottom frame 11 for supporting the object 8, a reclining frame 12 extending upwardly from a rear edge of the bottom frame 11, and a wheel unit 13 connected to a lower portion of the reclining frame 12.

The reclining frame 12 includes a pair of spaced-apart columns 121 extending upwardly from the rear edge of the bottom frame 11, a handle member 122 interconnecting top ends of the columns 121, a first rib 123 interconnecting the columns 121 and disposed between the handle member 122 and the bottom frame 11, and a plurality of second ribs 124. Each of the second ribs 124 interconnects the columns 121 and is disposed between the handle member 122 and the first rib 123. The reclining frame 12 further includes a third rib 125 disposed between the columns 121 and connected to the first rib 123, the second ribs 124 and the bottom frame 11. However, the configuration of the first, second and third ribs 123, 124, 125 is not limited to such.

The wheel unit 13 includes a pair of wheel seats 133 connected respectively to lower portions of the columns 121 of the reclining frame 12, an axle 132 extending through the wheel seats 133, and a pair of wheels 131 connected respectively to opposite ends of the axle 132. The configuration of the wheel unit 13 and the number of the wheels 131 may vary in other embodiments of this invention.

The fulcrum shaft 20 is mounted to the reclining frame 12 of the main body 1, is substantially horizontal, interconnects the columns 121 of the reclining frame 12, and is disposed between the first rib 123 and the bottom frame 11.

The push member 2 has a driving portion 21 disposed above the bottom frame 11, a driven portion 22 disposed oppositely of the driving portion 21 and behind the reclining frame 12 to be operated by a user, and a pair of spaced apart levers 23, each of which is fulcrumed about the fulcrum shaft 20 and interconnects the driving portion 21 and the driven portion 22. The push member 2 is operable to move between a non-pushing position (see FIG. 4) where the driving portion 21 is retracted backward to permit placement of the object 8 on the bottom frame 11, and a pushing position (see FIG. 5) where the driving portion 21 extends forward of the reclining frame 12 to push the object 8 forward and outward from the bottom frame 11.

Each of the levers 23 is configured as a Z-shaped plate, and has a first segment 231 connected between the driven portion 22 and the fulcrum shaft 20, and a second segment 232 connected between the driving portion 21 and the fulcrum shaft 20. The driving portion 21 has a connecting part 212 connected pivotally to the second segments 232 of the levers 23, and an abutment surface 211 opposite to the connecting part 212 for pushing the object 8. The push member 2 may have only one lever 23, and the levers 23 may be L-shaped or other shapes.

In this embodiment, the first resilient member 3 is connected between the first rib 123 and the first segment 231 of one of the levers 23 for biasing the push member toward the non-pushing position, and the second resilient member 4 is connected between the driving portion 21 and the second segment 232 of one of the levers 23 for biasing the abutment surface 211 to face forward when the push member 2 is at the non-pushing position. The first resilient member 3 biases the first segments 231 of the levers 23 to pivot upward and the second segments 232 of the levers 23 to pivot downward.

The first and second resilient members 3, 4 in this embodiment are configured as extension springs, but may be configured as torsion springs or rubber springs.

Since the first resilient member 3 biases the push member 2 toward the non-pushing position, when the push member 2 is not operated by a user, the driving portion 21 is close to the reclining frame 12 to permit placement of the object 8 on the bottom frame 11. At this time, the driven portion 22 is relatively high above the ground.

After arriving at a destination, the hand truck of this invention is pushed forward by the user until the bottom frame 11 contacts the ground. Then the user steps on the driven portion 22 of the push member 2 to move the push member 2 to the pushing position, i.e., to pivot the driven portion 22 downwardly (indicated by the arrow 5 in FIG. 4) such that the driving portion 21 pivots upwardly and forwardly to push the object 8 forward and outward from the bottom frame 11.

Specifically, since the driving portion 21 is connected pivotally to the second segments 232 of the levers 23, during the switch of the push member 2 from the non-pushing position to the pushing position, the abutment surface 211 can abut steadily against the object 8. Moreover, by virtue of the second resilient member 4, after the object 8 is removed from the bottom frame 11, the driving portion 21 would restore to an initial state where the abutment surface 211 faces forward when the push member 2 is back to the non-pushing position.

To sum up, by the configuration of the push member 2, a user can easily unload the object 8 from the bottom frame 11 by pedaling the push member 2 so that the transportation of the object 8 is both laborsaving and timesaving.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A hand truck for transporting an object, comprising:
a movable main body including
a bottom frame adapted for supporting the object, and
a reclining frame extending upwardly from a rear edge of said bottom frame;
a push member fulcrumed to said reclining frame and having a driving portion that is disposed above said bottom frame, said push member being operable to move between a non-pushing position where said driving portion is retracted backward to permit placement of the object on said bottom frame, and a pushing position where said driving portion extends forward from said reclining frame to push the object forward and outward from said bottom frame; and
a first resilient member connected between said main body and said push member for biasing said push member toward the non-pushing position.

2. The hand truck as claimed in claim 1, further comprising a fulcrum shaft mounted to said reclining frame, said push member being fulcrumed about said fulcrum shaft, and further having a driven portion disposed oppositely of said driving portion and behind said reclining frame to be operated by a user.

3. The hand truck as claimed in claim 2, wherein said push member further has a pair of spaced apart levers, each of which is fulcrumed about said fulcrum shaft and interconnects said driving portion and said driven portion.

4. The hand truck as claimed in claim 3, wherein:
each of said levers has a first segment connected between said driven portion and said fulcrum shaft, and a second segment connected between said driving portion and said fulcrum shaft; and
said driving portion has a connecting part connected pivotally to said levers, and an abutment surface opposite to said connecting part for pushing the object.

5. The hand truck as claimed in claim 4, further comprising a second resilient member connected between said driving portion and said second segment of one of said levers for biasing said abutment surface to face forward.

6. The hand truck as claimed in claim 5, wherein said first and second resilient members are configured as extension springs.

7. The hand truck as claimed in claim 5, wherein said reclining frame of said main body includes a pair of spaced-apart columns extending upwardly from said rear edge of said bottom frame, said fulcrum shaft being substantially horizontal and interconnecting said columns, said reclining frame further including a first rib that interconnects said columns and that is disposed above said fulcrum shaft, said first resilient member being connected between said first rib and said first segment of one of said levers of said push member.

8. The hand truck as claimed in claim 7, wherein said reclining frame further includes a handle member interconnecting top ends of said columns, and a plurality of second ribs, each of which interconnects said columns and is disposed between said handle member and said first rib.

9. The hand truck as claimed in claim 8, wherein said reclining frame further includes a third rib disposed between said columns and connected to said first rib, said second ribs and said bottom frame.

10. The hand truck as claimed in claim 9, wherein said main body further includes a wheel unit including
a pair of wheel seats connected respectively to lower portions of said columns,
an axle extending through said wheel seats, and
a pair of wheels connected respectively to opposite ends of said axle.

11. The hand truck as claimed in claim 4, wherein said first resilient member biases said first segments of said levers to pivot upward and biases said second segments of said levers to pivot downward.
